(19) United States
(12) Patent Application Publication
(10) Pub. No.: US 2003/0145844 A1
(43) Pub. Date: Aug. 7, 2003

(54) Multiwire saw with improved bearing

(75) Inventors: Jorg Lukschandel, Kempten (DE); Josef Kracker, Altusried (DE)

Correspondence Address: WILLIAM COLLARD, COLLARD & ROE, P.C., 1077 NORTHERN BOULEVARD, ROSLYN, NY, 11576, US

(73) Assignee: Wacker-Chemie GmbH

(21) Appl. No.: 10/353,898

(22) Filed: Jan. 29, 2003

(30) Foreign Application Priority Data
Feb. 1, 2002 (DE) 102 04 173.3

(51) Int. Cl. B28D 1/06

(52) U.S. Cl. 125/16.02; 125/21

(57) ABSTRACT

A wire saw and method for cutting wafers from a workpiece, in which a saw wire is guided multiple times around wire-guiding rolls. The wire-guiding rolls have a rotatable bearing arrangement and two adjacent wire-guiding rolls delimit a saw gate. The saw has ceramic sliding-contact bearings for rotatably bearing the wire-guiding rolls.

### BACKGROUND OF THE INVENTION

1. Field of the Invention

The invention relates to a multiwire saw with an improved bearing for the wire-guiding rolls.

2. The Prior Art

Multiwire saws are generally used to saw blocks or ingots of nonmetallic materials such as semiconductor material into thin wafers. In these saws, thin wire with a diameter of less than 0.2 mm is drawn over the workpiece to be cut up, with the addition of an aqueous slurry of abrasive grains, preferably SiC, the hard grains gradually causing material to be abraded. The term “cutting lapping” is also customary for this operation. Specialists in the field generally speak of “slurry sawing”. In this method, the progress of sawing is very slow, generally less than 1 mm per minute, so that the method is only economically viable if several cuts are made at the same time.

This is achieved as shown in FIGS. 1 and 2 by a wire 1 guided multiple times around diverting rolls provided with grooves 2, known as the wire-guiding rolls 3, thus forming what is known as a saw gate 4. The high demands imposed on planarity and plane-parallelism of the sawn wafers require not only a very accurate arrangement of wire-guiding grooves 2 in diverting rolls 3 but also extremely precise bearing 5 of the rolls 3 themselves.

During the sawing operation, which generally lasts several hours, there must be no change whatsoever in the overall arrangement, since otherwise the specification imposed for the sawn wafers is not achieved. Bearings 6 used to bear 5 the wire-guiding rolls 3 are therefore highly prestressed and have to be cooled by means of a coolant 9 in order to dissipate the frictional heat. To prevent both penetration of the coolant into the grease-lubricated metallic bearings 6 and contamination of the cooling liquid with grease 7 from the bearings 6, complex sealing 8 of bearings 6 of wire-guiding rolls 3 with respect to the coolant is required.

The entire arrangement of the saw gate 4 and of the diverting and drive rolls 3 (wire-guiding rolls) lies freely in the working space of the saw, since the abrasive suspension required to achieve the removal of material has to flow in and out without being impeded. Therefore, a further, absolutely secure seal of bearing arrangements 5 of wire-guiding rolls 3 with respect to this extremely abrasive medium is required.

Wire-guiding rolls 3 have a cooling system which is supplied with coolant 13 via rotary lead-throughs 12 sealed by means of seals 11. All the seals consume additional energy due to friction 8, 11 at the sealing points, and this in turn leads to heating of bearings 6 and to a loss of power on the part of the saw.

Numerous proposals have been made to replace the loose abrasive grain which is used to cut into the material being sawn with diamond particles which are secured directly to the saw wire (e.g. EP-A1 0982094). In this case too, there are fundamentally the same problems in terms of the bearing of the wire-diverting rolls as with the slurry sawing which has been described above.

### SUMMARY OF THE INVENTION

It is therefore an object of the invention to provide a wire saw for cutting wafers from a workpiece, in which a saw wire is guided multiple times around wire-guiding rolls, in which the wire-guiding rolls have a rotatable bearing arrangement and in which two adjacent wire-guiding rolls delimit a saw gate (a multiwire saw), which avoids the drawbacks and inadequacies of the prior art which have been described.

The object is achieved by a saw which has ceramic sliding-contact bearings for rotatably bearing the wire-guiding rolls.

The ceramic sliding-contact bearings which are provided in accordance with the invention replace the grease-lubricated metallic bearings which are customary in the prior art. They can preferably be lubricated with any type of liquid, in particular including with water.

The sliding-contact bearings preferably have water washing around them, i.e. the sliding film of water is constantly replaced (heat exchange). There is no need for auxiliary systems for lubrication and cooling, as required with oil-lubricated sliding-contact bearing applications. Ceramic sliding-contact bearings have extremely good sliding properties in the vicinity of water, since water reacts tribochemically at the sliding surfaces of the silicon carbide, where it forms a friction-reducing interlayer.

The ceramic sliding-contact bearing is preferably a sliding-contact bearing made from silicon carbide. Sliding-contact bearings of this type are commercially available, for example from Wacker-Chemie GmbH under the name EKaSiC® D, EKaSiC® C and EKaSiC® G.

Ceramic bearing materials, in particular silicon carbide, as is generally used for sliding-contact bearings, have a number of significant advantages over metals.

The modulus of elasticity of SiC is approximately twice as high as that of steel. Therefore, the bearing rigidity is significantly higher.

The coefficient of thermal expansion of SiC is only 25% of that of steel. Therefore, the deformation of the bearing surfaces when heated is significantly lower.

The thermal conductivity of SiC is four times as high as that of steel. This facilitates the dissipation of heat.

The hardness of silicon carbide, at HV 2500, is more than 3 times higher than that of hardened steel. This means that SiC is at what is known as the low point of wear with respect to abrasive particles of sawn semiconductor material, and therefore undergoes scarcely any wear even when such particles are present in the bearing gap.

Silicon carbide is extremely resistant to corrosion.

Silicon carbide sliding bearings do not require oils or greases as lubricant.

In general terms, sliding-contact bearings have a better damping performance than rolling bearings, and therefore the saw according to the invention also runs more smoothly.

The demands imposed on the bearing arrangement of diverting and drive rolls for the saw gate in multiwire saws, as described in connection with the prior art, can be satisfied in a significantly more satisfactory and simple way with ceramic sliding-contact bearings than has hitherto been the case:

The cooling and lubrication of the bearings can take place simultaneously using untreated water.

There is no need to seal the bearings. The water supplied can emerge from the bearing gaps into the working space of the saw without causing any damage, since in that region water is in any case present both during slurry sawing and during sawing with diamond-covered wire as a suspension carrier or coolant in large quantities.

There is no need for separate circuits for the sawing operation itself and the bearing cooling.

The elimination of the seals and the reduced prestress means that the overall bearing arrangement runs significantly more easily: less wire pulling force is lost in driving along the rolls.

The saw according to the invention therefore preferably does not have any seals for the bearings of the wire-guiding rolls. The saw according to the invention preferably does not have any separate cooling of the wire-guiding rolls.

The invention also relates to a method for cutting a semiconductor wafer from a single crystal by means of a saw, in which a saw wire works through the single crystal in a plurality of saw gaps. The saw used is a saw according to the invention. The method according to the invention makes it possible to increase the yield of semiconductor wafers from the single crystal, since the saw according to the invention makes it possible to reduce the cut width by reducing the diameter of the saw wire. The diverting rolls, which form the actual saw gate of a multiwire saw are not generally driven. The wire therefore has to move these rolls itself, and the tensile force required to do this is no longer available for the sawing work. Since the cut width has to be minimized in order to reduce the loss of expensive starting material, it preferable to keep the diameter of the saw wire as low as possible. Since the force required to carry along the undriven diverting rolls is reduced in the saw according to the invention due to the reduction of the losses in the bearing and sealing system, it is also possible for the wire diameter to be reduced in the saw according to the invention. Since the loss of material in some cases amounts to more than half the total sawing costs, the method according to the invention provides a significant economic advantage.

### BRIEF DESCRIPTION OF THE DRAWINGS

Other objects and features of the present invention will become apparent from the following detailed description considered in connection with the accompanying drawing. It is to be understood, however, that the drawings are designed as an illustration only and not as a definition of the limits of the invention. In the drawings:

FIG. 1 shows a perspective view of a multi-wire saw according to the prior art;

FIG. 2 shows a side view of the saw of FIG. 1; and

FIG. 3 shows a side view of the multi-wire saw according to the invention.

### DETAILED DESCRIPTION OF THE PREFERRED EMBODIMENT

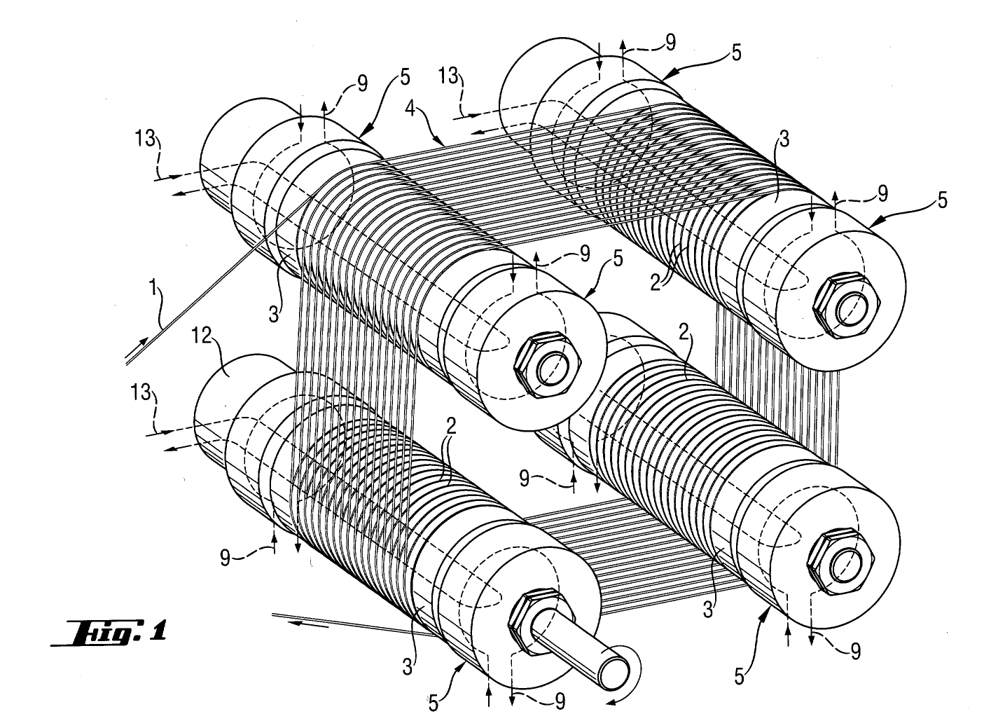

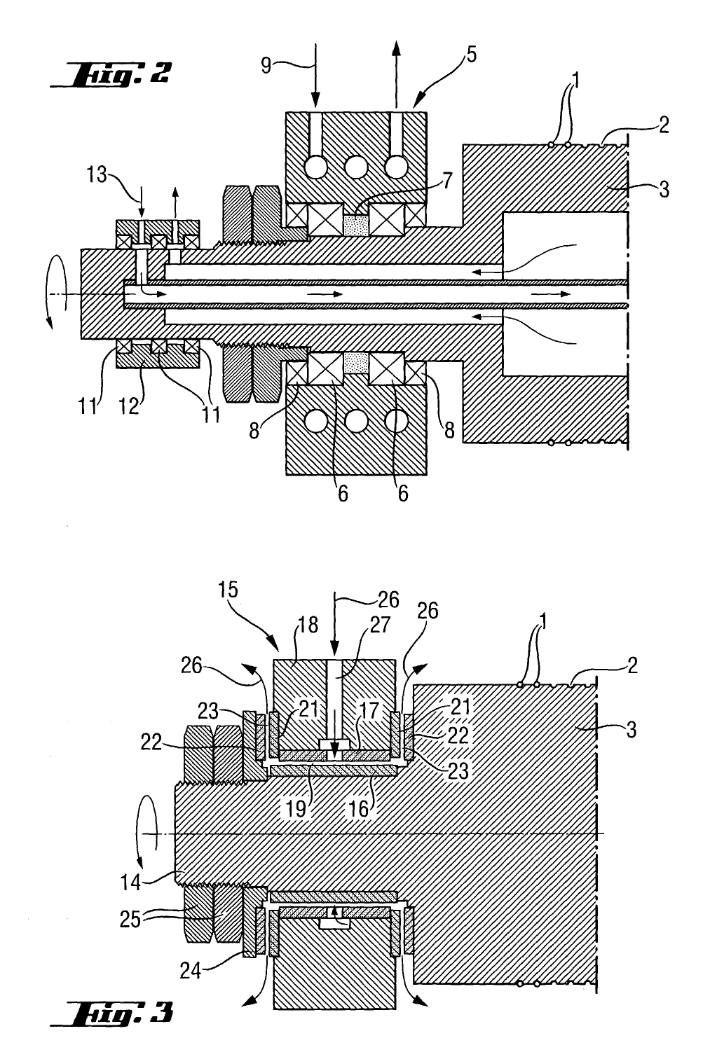

Referring now in detail to the drawings, FIGS. 1 and 2 show the saw of the prior art, which was discussed in detail above. FIG. 3 shows, by way of example, a detailed section through a bearing arrangement 15 according to the invention for a wire-guiding roll 3. For rotatable radial mounting of the journal 14 of the wire-guiding roll 3, journal 14 has a ceramic bush 16, the cylindrical outer surface of which interacts with a corresponding cylindrical inner surface of a bush 17 fixed in bearing housing 18, to form a bearing gap 19.

For axial bearing of the wire-guiding roll 3, the bearing housing 18 has end-side ceramic run-on disks 21, which interact with guide disks 22, which are correspondingly axially fixed to wire-guiding roll 3 or its journal 14, to form an axial bearing gap 23. The axial clearance of wire-guiding roll 3 is particularly advantageously made adjustable by means of spacer piece 24 and a screw connection 25.

Fluid 26 as lubricant/coolant is supplied to radial bearing gap 19 and also to axial bearing gaps 23 via a feed bore 27 in bearing housing 18 and in ceramic bush 17 and emerges freely from these bearing gaps into the surrounding area. The bearing gaps are illustrated in an exaggerated scale in FIG. 3, for the sake of clarity.

Accordingly, while only a single embodiment of the present invention has been shown and described, it is obvious that many changes and modifications may be made thereunto without departing from the spirit and scope of the invention.

What is claimed is:

1. A wire saw for cutting wafers from a workpiece, comprising:
a plurality of wire-guiding rolls, wherein two adjacent wire-guiding rolls comprise a saw gate;
a quantity of saw wire guided multiple times around the wire-guiding rolls; and
ceramic sliding-contact bearings for rotatably bearing the wire-guiding rolls.

2. The wire saw as claimed in claim 1, wherein the ceramic sliding-contact bearings consist of silicon carbide.

3. The wire saw as claimed in claim 1, wherein the bearings of the wire-guiding rolls are not sealed.

4. The wire saw as claimed in claim 1, wherein the bearings of the wire-guiding rolls do not have a separate cooling arrangement.

5. A method for cutting a semiconductor wafer from a single crystal by means of a saw, the saw comprising a plurality of wire-guiding rolls with two adjacent wire-guiding rolls comprising a saw gate, a quantity of saw wire guided multiple times around the wire-guiding rolls, and ceramic sliding-contact bearings for rotatably bearing the wire-guiding rolls, said method comprising working the saw wire through the single crystal in a plurality of saw gaps.
